(19) United States
(12) Patent Application Publication
(10) Pub. No.: US 2009/0058065 A1
(43) Pub. Date: Mar. 5, 2009

(54) Chassis frame for fuel cell vehicle

(75) Inventor: Chang Wook Park, Gyeonggi-Do (KR)

Correspondence Address: Edwards Angell Palmer& Dodge LLP, P.O. BOX 55874, Boston, MA, 02205, US

(73) Assignee: Hyundai Motor Company, Seoul (KR)

(21) Appl. No.: 11/999,977

(22) Filed: Dec. 6, 2007

(30) Foreign Application Priority Data
Sep. 3, 2007 (KR) 10-2007-0088764

(51) Int. Cl. B62D 21/18

(52) U.S. Cl. 280/830; 296/204

(57) ABSTRACT

A chassis frame for a fuel cell vehicle is disclosed. The chassis frame for the fuel cell vehicle, which is configured to form a lower vehicle body of the fuel cell vehicle and form a vehicle body of the fuel cell vehicle together with an upper body, the chassis frame comprising: two side members (210) each of which is arranged in a longitudinal direction of the vehicle body and includes three divisional frame units of a front member (211), a center member (212) and a rear member (213) that are connected in a longitudinal direction; a plurality of cross members (221, 222, 223, 224) transversely arranged between the two side members (210); and body mounting portions (217) for mounting the upper body (100).

### CROSS-REFERENCE TO RELATED APPLICATION

This application claims the benefit under 35 U.S.C. §119(a) on Korean Patent Application No. 10-2007-88764, filed on Sep. 3, 2007, the entire contents of which are incorporated herein by reference.

### BACKGROUND

1. Technical Field

The present invention relates to a chassis frame for a fuel cell vehicle, and more particularly, to a chassis frame for a fuel cell vehicle which constitutes a lower vehicle body of a fuel cell vehicle.

2. Background Art

Vehicle industry has rapidly grown centering on gasoline and diesel internal combustion engines for more than one hundred years, but it is now confronted by a tremendous change due to problems such as environmental regulations, threat to energy security and exhaustion of fossil fuel.

Many developed countries have entered into competition of developing future vehicles with environment-friendly, high efficient and high-tech features, and major vehicle companies are trying to survive in such keen competition.

In accordance with the demand of the times for environment-friendly products which can resolve a fossil fuel exhaustion problem, vehicle companies have been actively developing electric vehicles which use an electric motor as a power source.

In this connection, research on a vehicle with a fuel cell system mounted thereon has been actively undergone.

As well known, a vehicle with a fuel cell system supplies hydrogen to a fuel cell stack as fuel to generate electric energy which is used to operate an electric motor to drive a vehicle.

Here, a fuel cell system is a sort of a power generating system which does not change chemical energy in fuel to heat by combustion but electrochemically generates electric energy therein.

A fuel cell system comprises a fuel cell stack for generating electric energy, a fuel supplying system for supplying fuel (hydrogen) to the fuel cell stack, an air supplying system for supplying oxygen in the air as an oxidizer used in an electrochemical reaction, and a heat/water management system for externally discharging reaction heat of the fuel cell stack and controlling a driving temperature of the fuel cell stack.

In such a fuel cell system, electric energy is generated by an electrochemical reaction of hydrogen as fuel and oxygen in the air, generating heat and water as a reaction byproduct.

As a fuel cell system, a proton exchange membrane fuel cell (PEMFC) is widely used due to high output density.

Meanwhile, a conventional fuel vehicle has a vehicle body of a box-type structure called “a monocoque body” which does not have a frame.

The monocoque body is configured by a combination of thin panels and reinforcing members to provide an engine room, a passenger room and a trunk room and is designed to distribute an external force caused in the event of a vehicle crash to the whole body.

In the conventional vehicle body structure, a humidifier for humidifying air supplied to a fuel cell stack, the fuel cell stack for generating electric energy by an electrochemical reaction between hydrogen as fuel and oxygen in the air, and a fuel processing system for controlling pressure of hydrogen supplied from a hydrogen tank to supply hydrogen as fuel are mounted in an engine room of a monocoque body, whereas a plurality of hydrogen tanks are mounted below a rear floor of a monocoque body.

The humidifier and the fuel cell stack mounted in a fuel cell vehicle are very heavy in weight.

If these heavy parts are mounted in the engine room of the monocoque body, a monocoque body configured by combining very thin panels which are mold-manufactured may not endure the strength and, so the monocoque body may become very weak in durability for enduring an external force. That is, providing the monocoque body with sufficient strength requires its structure to be more complicated.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to solve the aforementioned problems associated with prior art and one object of the present invention is to provide a chassis frame for a fuel cell vehicle platform which forms a lower vehicle body to be applied to a frame body of a fuel cell vehicle, form a vehicle body of the fuel cell vehicle together with an upper body, and provides spaces in which a humidifier, a fuel cell stack, a FPS, and a hydrogen tank are mounted. Another object is to provide a chassis frame for a fuel cell vehicle which includes sectioned members and the stiffness, cross section and weight of the members can be adjusted independently.

In a preferred embodiment, the present invention a chassis frame for a fuel cell vehicle, which is configured to form a lower vehicle body of the fuel cell vehicle and form a vehicle body of the fuel cell vehicle together with an upper body, the chassis frame comprising: two side members (210) each of which is arranged in a longitudinal direction of the vehicle body and includes three divisional frame units of a front member (211), a center member (212) and a rear member (213) that are connected in a longitudinal direction; a plurality of cross members (221, 222, 223, 224) transversely arranged between the two side members (210); and body mounting portions (217) for mounting the upper body (100).

In another preferred embodiment, a humidifier (11), a fuel cell stack (12), a FPS (13), and hydrogen tanks (14a, 14b) are mounted in the order along the front member (211), the center member (212) and the rear member (213).

In still another preferred embodiment, the second cross member (222) and the third cross member (223) are arranged between the front members (211) of the side members (210) and the fourth cross member (224) is arranged between the rear members (213) of the side members (210). Preferably, the humidifier (11) is located between the second cross member (222) and the third cross member (223), the fuel cell stack (12) is located between the third cross member (223) and the fourth cross member (224), and the FPS (13) and first and second hydrogen tanks (14a, 14b) are located behind the fourth cross member (224) in a longitudinal direction.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like.

Other aspects of the invention are discussed infra.

### BRIEF DESCRIPTION OF THE DRAWINGS

The above and other features of the present invention will be described in reference to certain exemplary embodiments thereof with reference to the attached drawings in which:

FIG. 1 is a schematic view illustrating a vehicle body structure for a fuel cell vehicle according to an exemplary embodiment of the present invention;

FIG. 2 is a side view illustrating a chassis frame in the vehicle body structure of FIG. 1; and

FIG. 3 is a schematic side view illustrating the chassis frame of a three-sectioned structure of FIG. 2.

### DETAILED DESCRIPTION

Reference will now be made in detail to the embodiments of the present invention, examples of which are illustrated in the accompanying drawings, wherein like reference numerals refer to the like elements throughout. The embodiments are described below in order to explain the present invention by referring to the figures.

As discussed above, the present invention relates to a chassis frame for a fuel cell vehicle platform. The chassis frame forms a lower part of a vehicle body of the fuel cell vehicle. The lower part is coupled with an upper body to form a vehicle body (known monocoque body). It provides spaces in which a humidifier, a fuel cell stack, a FPS, and a hydrogen tank are mounted.

The chassis frame according to the present invention comprises a plurality of longitudinal members, a plurality of transverse members combined with the longitudinal members, and a plurality of body mounting portions for mounting the upper body. Particularly, the side member as the longitudinal member has a three-sectioned frame structure, in which a humidifier, a fuel cell stack, a FPS, and a hydrogen tank are mounted in an appropriate order in empty spaces where the transverse members are not arranged.

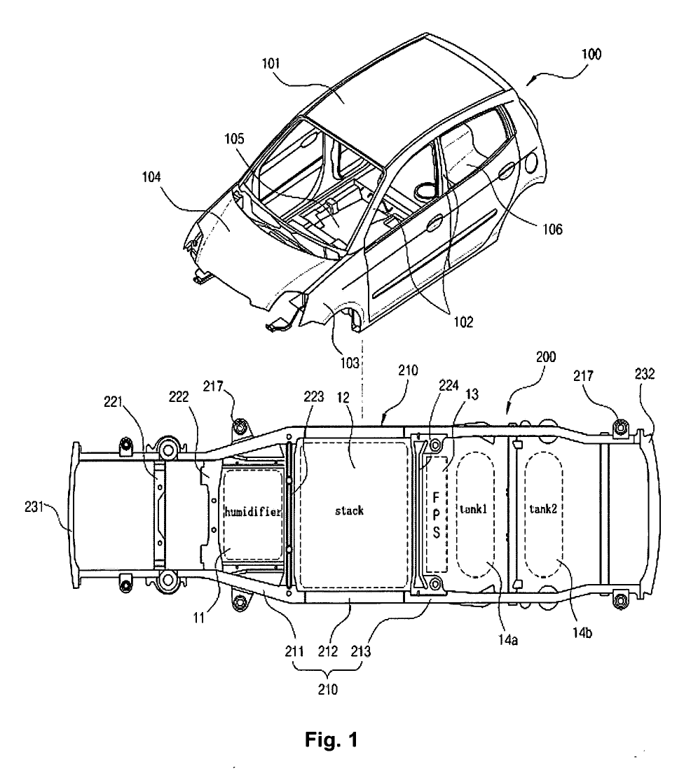

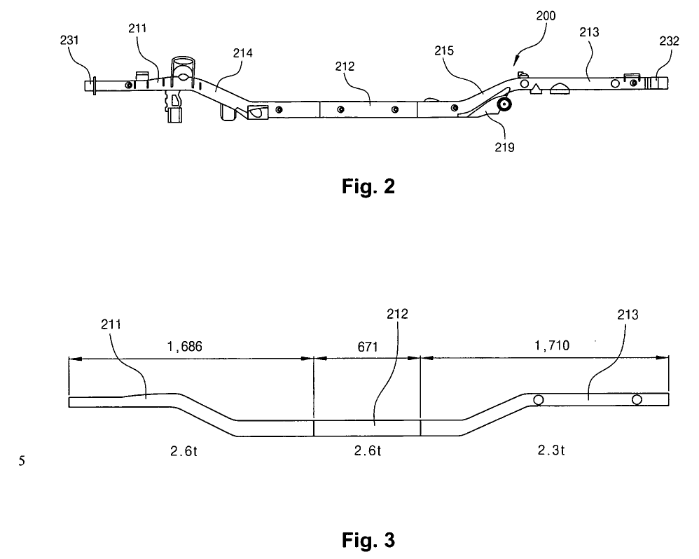

FIG. 1 is a schematic view illustrating a vehicle body structure for a fuel cell vehicle according to an exemplary embodiment of the present invention, FIG. 2 is a side view illustrating a chassis frame in the vehicle body structure of FIG. 1, and FIG. 3 is a schematic side view illustrating the chassis frame of a three-sectioned structure of FIG. 2.

As shown in the drawings, the vehicle body of the fuel cell vehicle according to the present invention comprises an upper body 100 and a chassis frame 200. The upper body 100 has a box-type structure that thin panels and reinforcing members are appropriately combined to provide an engine room, a passenger room, and a trunk room. The upper body 100 comprises a roof 101, a filler 102, a fender 103, a hood 104, a trunk lid (not shown), a dash panel (not shown), a center floor 105, and a rear floor 106 which are made by molding thin panels, like the monocoque body of the existing internal combustion engine.

The chassis frame 200 is configured by welding and combining two side members 210 (longitudinal members), a plurality of cross members (transverse members) 221 to 224, and bumper reinforcing members 231 and 232.

The chassis frame 200 is provided with a plurality of body mounting portions 217. The upper body 100 is to be coupled to the chassis frame 200 through the body mounting portions 217.

The chassis frame 200 comprises two side members 210, as longitudinal members, which are arranged in a front-rear direction of the vehicle body, first to fourth cross members 221 to 224, as transverse members, arranged in a transverse direction between the two side members 210, front and rear bumper reinforcing members 231 and 232, and additional reinforcing members (not shown).

In the chassis frame 200, each side member 210 comprises three divisional frame units: a front member 211, a center member 212 and a rear member 213. These three members are sequentially connected in a longitudinal direction to form each side member 210.

The front member 211, the center member 212, and the rear member 213 which constitute each side member 210 are configured in a tube-type form with a rectangular cross section, and one side member 210 is manufactured by welding end portions of the front member 211, the center member 212, and the rear member 213 of a tube-type structure with a rectangular cross section.

Here, the stiffness and weight of each member can be adjusted by applying different tube wall thickness to each member. For example, as shown in FIG. 3, one side member 210 may be manufactured such that the front member 211 and the center member 212 of the rectangular tube form with the tube wall thickness of 2.6 mm (2.6 t) and the rear member 213 of the rectangular tube form with the tube wall thickness of 2.3 mm (2.3 t) are prepared and then the end portions of the front member 211, the center member 212 and the rear member 213 are welded.

As described above, each side member 210 has a three divisional frame structure in which the three members 211, 212 and 213 are connected, and the chassis frame 200 is manufactured such that the first to fourth cross members 221 to 224 transversely arranged between the two side members 210 are welding-coupled to the side members 210.

In the chassis frame of the present invention, since the side member 210 has the three divisional frame structure in which the three members 211, 212 and 213 are serially connected, the frame stiffness, the wall thickness, the cross-section shape, the cross section dimension, and the weight of the rectangular tube which constitutes a frame can be different.

In the chassis frame 200 which comprises the side member 210 and the auxiliary members 221 to 224, a plurality of body mounting portions 217 are formed to mount the upper body 100 which is assembled onto the chassis frame 200, and a suspension arm bracket 219 to which a rear suspension arm is coupled is arranged in the rear member 213 of each side member 210.

Also, the side member 210 of the chassis frame 200 has kick-up portions 214 and 215 to lower the height of the center floor portion of the upper body 100. The kick-up portions 214 and 215 are formed such that a rear portion of the front member 211 and a front portion of the rear member 213 which are connected by the center member 212 are inclined downwards as shown in FIGS. 2 and 3. That is, the kick-up portions 214 and 215 are formed by a height difference between each of the front and rear members 211 and 213 and the center member 212.

That is, as shown in FIGS. 2 and 3, the front kick-up portion 214 is formed by a height difference between the front member 211 and the center member 212 of the side member 210, and the rear kick-up portion 215 is formed by a height difference between the center member 212 and the rear member 213 of the side member 210.

The height of the front member 211, the center member 212 and the rear member 213 depends on a vehicle layout. That is, the height of the front member 211 and the rear member 213 is determined by a structure of a suspension member, and the height of the center member 212 is determined in consideration of the requirement of enough distance between the upper body and the center floor.

In the fuel cell vehicle according to the present invention, heavy-weight components, which are mounted in the engine room of the monocoque body according to a prior art structure, are mounted on and are supported by the chassis frame. That is, a humidifier 11, a fuel cell stack 12, a FPS 13, and a hydrogen tank 14 are mounted along the front member 211, the center member 212 and the rear member 213.

In more detail, the humidifier 11 is located between the second cross member 222 and the third cross member 223 arranged between the front members 211 of the side members 210, the fuel cell stack 12 is located between the third cross member 223 and the fourth cross member 224 arranged between the rear members 213 of the side members 210, and the FPS 13 and first and second hydrogen tanks 14a and 14b are located behind the fourth cross member 224.

Preferably, even though not shown, the humidifier 11 is supported such that it is mounted to the second and third cross members 222 and 223, the fuel cell stack 12 is supported such that it is mounted to the second and third cross members 222 and 223 and the center members 212 of the side members 210, the FPS 13 is supported such that it is mounted to the fourth cross member 224, and the first and second hydrogen tanks 14a and 14b are supported such that they are mounted to the rear members 213 of the side members 210.

In the chassis frame according to the present invention, due to the side member of the three divisional frame structure, the stiffness, the tube wall thickness, the cross section shape and dimension, and the weight of the front member, the center member and the rear member can be set differently from each other in consideration of the weight of the mounted components (e.g., humidifier, fuel cell stack, FPS, and hydrogen tank) and their required strength. Therefore, an optimum cross section for the frame can be set, reducing the weight of the vehicle body.

As described above, according to the present invention, the chassis frame is configured to mount the heavy-weight components such as the humidifier and the fuel cell stack, and so it is possible to constitute the vehicle body with the higher durability and strength, compared to the conventional vehicle body structure in which the heavy-weight components are mounted in the engine room of the monocoque body.

Also, the chassis frame of the present invention can have different member stiffness and cross section and weight according to the divided section since the side member has the three-sectioned frame structure that three member are connected.

Although the present invention has been described with reference to certain exemplary embodiments thereof, it will be understood by those skilled in the art that a variety of modifications and variations may be made to the present invention without departing from the spirit or scope of the present invention defined in the appended claims, and their equivalents.

1-4. (canceled)

5. A chassis frame for a fuel cell vehicle, which is configured to form a lower vehicle body of the fuel cell vehicle and form a vehicle body of the fuel cell vehicle together with an upper body, the chassis frame comprising:
two side members each of which is arranged in a longitudinal direction of the vehicle body and includes three divisional frame units of a front member, a center member and a rear member that are connected in a longitudinal direction, the stiffness and weight of each of the front member, the center member and the rear member being different from each other;
a plurality of cross members transversely arranged between the two side members; and
body mounting portions for mounting the upper body.

6. The chassis frame for the fuel cell vehicle of claim 5, wherein a humidifier, a fuel cell stack, a FPS, and hydrogen tanks are mounted in the order along the front member, the center member and the rear member.

7. The chassis frame for the fuel cell vehicle of claim 5, the second cross member and the third cross member are arranged between the front members of the side members and the fourth cross member is arranged between the rear members of the side members.

8. The chassis frame for the fuel cell vehicle of claim 7, wherein the humidifier is located between the second cross member and the third cross member, the fuel cell stack is located between the third cross member and the fourth cross member, and the FPS and first and second hydrogen tanks are located behind the fourth cross member in a longitudinal direction.
